(19) United States
(12) Patent Application Publication
(10) Pub. No.: US 2021/0125068 A1
(43) Pub. Date: Apr. 29, 2021

(54) METHOD FOR TRAINING NEURAL NETWORK

(71) Applicant: MakinaRocks Co., Ltd., Seoul (KR)

(72) Inventors: Ki Hyun KIM, Yongin-si (KR); Minhwan KIM, Seoul (KR); Byungchan KIM, Seoul (KR); Sungho YOON, Seoul (KR); Hooncheol SHIN, Seoul (KR)

(21) Appl. No.: 17/083,178

(22) Filed: Oct. 28, 2020

(30) Foreign Application Priority Data
Oct. 28, 2019 (KR) 10-2019-0134213
Feb. 24, 2020 (KR) 10-2020-0022453

(51) Int. Cl. G06N 3/08; G06F 3/0482; G06F 3/0481; G06K 9/62

(52) U.S. Cl. CPC G06N 3/08; G06F 3/0482; G06K 9/6298; G06K 9/6256; G06F 3/04812

(57) ABSTRACT

Disclosed is a computer program stored in a computer readable storage medium, in which when the computer program is executed in one or more processors, the computer program performs operations for training a neural network, the operations including: displaying a first screen including at least one first object receiving a selection input for a project; and displaying a second screen for displaying information related to the project corresponding to the selected project, in which the second screen includes at least one of a first output portion for displaying time series data obtained from a sensor or a second output portion for displaying a selection portion including at least one second object for receiving a selection input related to a model retraining or information corresponding to the second object.

### CROSS-REFERENCE TO RELATED APPLICATIONS

This application claims priority to and the benefit of Korean Patent Application No. 10-2020-0022453 filed in the Korean Intellectual Property Office on Feb. 24, 2020, and claims priority to and claims priority to and the benefit of Korean Patent Application No. 10-2019-0134213 filed in the Korean Intellectual Property Office on Oct. 28, 2019, the entire contents of which are incorporated herein by reference.

### BACKGROUND

### Technical Field

The present disclosure relates to a method of training a neural network, and more particularly, to a method of providing a user interface for training a neural network.

### Description of the Related Art

Deep learning is a set of machine learning algorithms that attempt high-level abstraction through a combination of several nonlinear transformation techniques.

Various types of research on machine learning algorithms are being conducted, and accordingly, various deep learning techniques, such as a deep neural network, a convolutional neural network, and a recurrent neural network, are applied to fields, such as a computer vision, voice recognition, and natural language processing.

The machine learning algorithm may have a complex structure and output a result through a complex computation. In order to process data by using the machine learning algorithm, considerable understanding of the machine learning algorithm must be preceded, and thus, users who can use machine learning algorithms are limited.

As the fields using machine learning algorithms diversify, there are rapid increases in attempts to incorporate, by experts in other domains who do not have a significant understanding of machine learning algorithms, the machine learning algorithms into their specialized fields.

Therefore, there is a need in the art to enable users to easily access the machine learning algorithms.

Korean Patent Application Laid-Open No. 2016-0012537 discloses a method and an apparatus for training a neural network, and a data processing device.

### BRIEF SUMMARY

The present disclosure is conceived in response to the background art, and has been made in an effort to provide a method of training a neural network.

An exemplary embodiment of the present disclosure for achieving the object provides a computer program stored in a computer readable storage medium, and the computer program performs operations for training a neural network when the computer program is executed in one or more processors, the operations including: displaying a first screen including at least one first object receiving a selection input for a project; and displaying a second screen for displaying information related to the project corresponding to the selected project, in which the second screen includes at least one of a first output portion for displaying time series data obtained from a sensor or a second output portion for displaying a selection portion including at least one second object for receiving a selection input related to a model retraining or information corresponding to the second object.

In an alternative exemplary embodiment of the operations of the computer program for performing the operations for providing a method of training the neural network, the project is a project related to artificial intelligence for achieving a specific goal based on the artificial intelligence, and the specific goal may include the goal of improving the performance of the model to which the artificial intelligence is applied.

In the alternative exemplary embodiment of the operations of the computer program for performing the operations for providing a method of training the neural network, the selection portion is a portion including an object for displaying information related to training of the model in the second output portion, and the selection portion may include at least one of a performance monitoring selection object for displaying information on performance of the model in the second output portion, a training dataset selection object for displaying information on a training dataset related to the model training in the second output portion, a training console selection object for displaying information on a training progress status related to the current model in the second output portion, a model archive selection object for displaying information related to at least one or more models in the second output portion, or a sensed anomaly output selection object for displaying anomaly information sensed by using the model in the second output portion.

In the alternative exemplary embodiment of the operations of the computer program for performing the operations for providing a method of training the neural network, the operations may further include displaying a training dataset output screen in the second output portion, and the training dataset output screen may include at least one of a training dataset list for listing at least one training dataset, a training dataset additional object for receiving a selection input for the training dataset to be used in a model training from a user, or a training dataset removal object for receiving a selection input for the training dataset to be not used in the model training from a user.

In the alternative exemplary embodiment of the operations of the computer program for performing the operations for providing a method of training the neural network, the training dataset may include at least one of a first training dataset used in a model training or a second training dataset to be newly used in a model retraining, and the second training dataset may include at least a part of the time series data obtained from a sensor in real time and a label corresponding to the time series data.

In the alternative exemplary embodiment of the operations of the computer program for performing the operations for providing a method of training the neural network, the operations may further include displaying a training dataset selection screen that allows the user to select the second training dataset.

In the alternative exemplary embodiment of the operations of the computer program for performing the operations for providing a method of training the neural network, the training dataset selection screen may be a screen for allowing a user to select the second training dataset, and the training dataset selection screen may include at least one of a time variable setting portion for filtering data obtained by inputting the time series data into the model based on a predetermined first reference or a data chunk portion for displaying data chunk divided from data obtained by inputting the time series data into the model based on a predetermined second reference.

In the alternative exemplary embodiment of the operations of the computer program for performing the operations for providing a method of training the neural network, the data chunk may include statistical features of each dataset obtained by inputting the plurality of time series data divided based on the predetermined second reference into the model.

In the alternative exemplary embodiment of the operations of the computer program for performing the operations for providing a method of training the neural network, the predetermined second reference is a reference for detecting a misclassification data from data obtained by using the model, and the predetermined second reference may include a reference for dividing data obtained by inputting the time series data into the model into a plurality of data chunks based on at least one of a first point where the data obtained by using the model changes from a first state to a second state, and a second point where an output of the model changes from the second state to the first state.

In the alternative exemplary embodiment of the operations of the computer program for performing the operations for providing a method of training the neural network, the data chunk may include at least one of a data chunk calculated through a data chunk recommendation algorithm that recommends a data chunk to be used for retraining the model to the user, or a data chunk including at least one data chunk with similar statistical characteristics to the data chunk selected from receiving a user selection input signal.

In the alternative exemplary embodiment of the operations of the computer program for performing the operations for providing a method of training the neural network, the operations may further include displaying a model archive output screen in the second output portion.

In the alternative exemplary embodiment of the operations of the computer program for performing the operations for providing a method of training the neural network, the model archive output screen may be a screen for displaying information of each model among a plurality of models, and the model archive output screen may include at least one of a model list output portion for displaying to be seen the plurality of models stored in the model archive at a glance or a model information output portion for displaying information of the model selected from receiving a user selection input signal.

In the alternative exemplary embodiment of the operations of the computer program for performing the operations for providing a method of training the neural network, the model list may include at least one of a model trained by progressing the project, a model retrained by inputting the second training dataset into the trained model, a model generated newly by integrating models having similar statistical characteristics among the plurality of models included in the model archive, or a model determined based on a hit rate of each model among the plurality of models included in the model archive in order to recommend a model corresponding to a data inputted newly to a user.

In the alternative exemplary embodiment of the operations of the computer program for performing the operations for providing a method of training the neural network, the operations may further include displaying an anomaly output screen sensed in the second output portion.

In the alternative exemplary embodiment of the operations of the computer program for performing the operations for providing a method of training the neural network, the sensed anomaly output screen may be a screen for displaying information related to an anomaly data from data obtained by using the model, and the sensed anomaly output screen may include at least one of an anomaly sensing result output portion for displaying an anomaly data list obtained by using the model or an anomaly information output portion for displaying information of the anomaly data selected from receiving a user selection input signal.

Another exemplary embodiment of the present disclosure for achieving the object provides a method of training a neural network, the method including: displaying a first screen including at least one first object for receiving a selection input for a project; and displaying a second screen for displaying information related to the project corresponding to the selected project, in which the second screen includes at least one of a first output portion for displaying time series data obtained from a sensor or a second output portion for displaying a selection portion including at least one second object for receiving a selection input for a model retraining or information corresponding to the second object.

Still another exemplary embodiment of the present disclosure for achieving the object provides a computing device for providing methods for training neural networks, the computing device including: a processor including one or more cores; and a memory, in which the processor displays a first screen including at least one first object receiving a selection input for a project, and display a second screen including information related to the project corresponding to the selected proj ect, and the second screen includes at least one of a first output portion for displaying time series data obtained from a sensor or a second output portion for displaying a selection portion including at least one second object for receiving a selection input for a model retraining or information corresponding to the second object.

The present disclosure may provide the method of training a neural network.

### BRIEF DESCRIPTION OF THE SEVERAL VIEWS OF THE DRAWINGS

Some of the exemplary embodiments are illustrated in the accompanying drawings so that the features of the present disclosure mentioned above may be understood in detail with more specific description with reference to the following exemplary embodiments. Further, similar reference numerals in the drawings are intended to refer to the same or similar functions over several aspects. However, it should be noted that the accompanying drawings show only specific exemplary embodiments of the present disclosure, and are not considered to limit the scope of the present disclosure, and other exemplary embodiments having the same effect may be sufficiently recognized.

FIG. 1 is a block diagram illustrating a computing device performing an operation for providing a method of training a neural network according to an exemplary embodiment of the present disclosure.

FIG. 2 is a diagram illustrating an example of a neural network that is a target for training in the method of training the neural network according to the exemplary embodiment of the present disclosure.

FIG. 3 is a diagram illustrating an example of a first screen according to the exemplary embodiment of the present disclosure.

FIG. 4 is a diagram illustrating an example of a second screen according to the exemplary embodiment of the present disclosure.

FIG. 5 is a diagram illustrating an example of a training dataset output screen according to the exemplary embodiment of the present disclosure.

FIG. 6 is a diagram illustrating an example of a training dataset selection screen according to the exemplary embodiment of the present disclosure.

FIG. 7 is a diagram illustrating an example of a model archive output screen according to the exemplary embodiment of the present disclosure.

FIG. 8 is a diagram illustrating an example for explaining a hit model according to the exemplary embodiment of the present disclosure.

FIG. 9 is a diagram illustrating an example for explaining a combined model according to the exemplary embodiment of the present disclosure.

FIG. 10 is a diagram illustrating an example of a sensed anomaly output screen according to the exemplary embodiment of the present disclosure.

FIG. 11 is a diagram illustrating an example of a model performance output screen according to the exemplary embodiment of the present disclosure.

FIG. 12 is a flowchart illustrating the method of training the neural network according to the exemplary embodiment of the present disclosure.

FIG. 13 is a simple and general schematic diagram illustrating an example of a computing environment in which the exemplary embodiments of the present disclosure are implementable.

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a server may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as Internet, through data and/or a signal from one component interacting with another component in a local system and a distributed system) having one or more data packets.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

A term “include” and/or “including” shall be understood as meaning that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

The term “at least one of A and B” should be interpreted to mean “a case including only A”, “a case including only B”, and “a case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure. The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

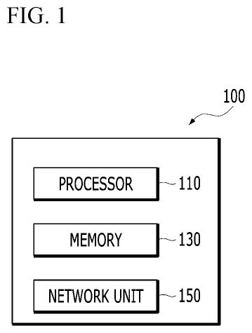

FIG. 1 is a block diagram illustrating a computing device performing an operation for providing a method of training a neural network according to an exemplary embodiment of the present disclosure.

The configuration of the computing device 100 illustrated in FIG. 1 is merely a simplified example. In the exemplary embodiment of the present disclosure, the computing device 100 may include other configurations for executing a computing environment of the computing device 100, and only a part of the disclosed configurations may also form the computing device 100.

The computing device 100 may include a processor 110, a memory 130, and a network unit 150.

According to the exemplary embodiment of the present disclosure, the processor 110 may provide a user interface for training a neural network. The user interface may include a first screen including at least one first object for receiving a selection input for a project.

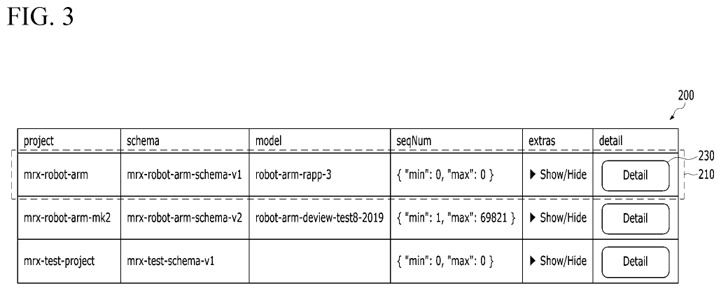

The first screen will be described in detail with reference to FIG. 3.

According to the exemplary embodiment of the present disclosure, the processor 110 may display a first screen 200 including at least one first object 230 for receiving a selection input for a project. A project 210 may include an artificial intelligence-related project for achieving a specific goal by using artificial intelligence. In particular, the project 210 may include a deep learning-related project for achieving a specific goal by using deep learning. The first object 230 may include an object for selecting the project 210. The first object 230 may include a function of moving to a second screen for the selected project 210. The first object 230 may include, for example, an icon in the screen. The first screen 200 may be the screen on which at least one project conducted by a user is displayed. The first screen 200 may include a screen for displaying a plurality of projects conducted by the user so that the user easily sees the plurality of projects at a glance. The selection input may include an input signal including information on an item selected by the user. Accordingly, when the processor 110 receives the selection input, the processor 110 may perform a computation based on the corresponding selection or display a result for the selection input on the screen. The foregoing matter is merely illustrative, and the present disclosure is not limited thereto.

According to the exemplary embodiment of the present disclosure, the project 210 may include an artificial intelligence-related project for achieving a specific goal by using the artificial intelligence. The specific goal may include a goal for maintaining and managing a model to which the artificial intelligence is applied, and may include, for example, a goal for improving performance of a model to which the artificial intelligence is applied. The specific goal may include, for example, improvement of accuracy of prediction of the model, a decrease in a training time of the model, and a decrease in the amount of computation or the amount of power used in training the model. Further, the specific goal may also include a goal for generating a model for obtaining a prediction value (for example, a stock price prediction in the case of finance) in a specific domain (for example, manufacturing business, medical treatment, legal business, administration, and finance). The foregoing matter is merely illustrative, and the present disclosure is not limited thereto.

According to the exemplary embodiment of the present disclosure, the processor 110 may display the second screen for displaying project-related information corresponding to the selected project. The second screen may include a screen for displaying project-related information corresponding to the corresponding selection input by the processor 110 according to the reception of the selection input of the first screen. The foregoing matter is merely illustrative, and the present disclosure is not limited thereto.

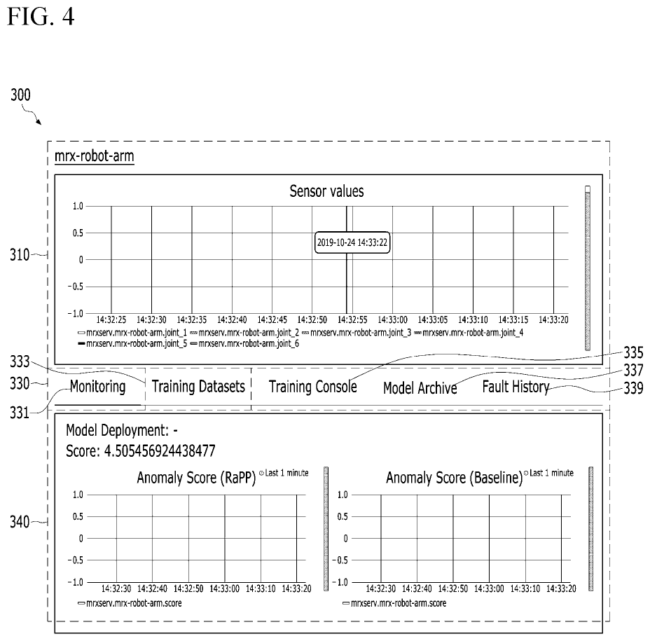

The second screen will be described in detail with reference to FIG. 4.

According to the exemplary embodiment of the present disclosure, the processor 110 may display the second screen 300 for displaying project-related information corresponding to the selected project. The second screen 300 may include a screen displaying information about a specific project. The second screen 300 may include a screen for displaying information required for improving performance of the deep learning model by the user. The second screen 300 may include, for example, a user interface in which information for improving performance of the deep learning model is displayed. Accordingly, the second screen 300 may include information on performance of the model, information on a training dataset used in training the model, a prediction value output by using the model by the processor 110, and the like. The foregoing matter is merely illustrative, and the present disclosure is not limited thereto.

According to the exemplary embodiment of the present disclosure, the second screen may include at least one of a first output portion 310 for displaying time series data obtained from a sensor, a selection portion 330 including at least one second object for receiving a selection input related to a model retraining, and a second output portion 340 for displaying information corresponding to the second object. The first output portion 310 may include a portion for displaying time series data obtained from the sensor. For example, the first output portion 310 may include a portion for displaying time series data obtained from the sensor in real time. The time series data obtained from the sensor may include, for example, time series data obtained from a sensor attached to a joint of a robot, time series data obtained from a material measuring sensor, temperature data, wind direction and wind speed data, ultraviolet sensor data, infrared sensor data, light sensor data, and sound sensor data. The second output portion 340 may include a portion for displaying information corresponding to the second object. The processor 110 may receive a selection input for the second object and display information corresponding to the second object. For example, when the processor 110 receives the selection input for the second object (for example, a training data selection icon), the processor 110 may display information related to the training data in the second output portion 340. The selection portion may include a portion including at least one second object for receiving a selection input related to the re-training of the model. The selection portion 330 may be a portion including an object for displaying information related to the training of the model in the second output portion. For example, the selection portion 330 may include a plurality of icons in the user interface so that the user may see desired information related to the re-training of the model through the second output portion. The foregoing matter is merely illustrative, and the present disclosure is not limited thereto.

According to the exemplary embodiment of the present disclosure, the selection portion is a portion including an object for displaying the information related to the training of the model in the second output portion, and may include at least one of a performance monitoring selection object 331 for displaying performance information of the model in the second output portion, a training dataset selection object 333 for displaying training dataset information related to the training of the model in the second output portion, a model archive selection object 337 for displaying information about at least one model in the second output portion, and a sensed anomaly output selection object 339 for displaying information on anomaly sensed by using the model in the second output portion. The foregoing matter is merely illustrative, and the present disclosure is not limited thereto.

According to the exemplary embodiment of the present disclosure, the performance monitoring selection object 331 may include an object for displaying performance information of the model in the second output portion. For example, when the processor 110 receives a selection input for the performance monitoring selection object 331, the processor 110 may display model performance information (for example, accuracy of the prediction by the model) in the second output portion. The foregoing matter is merely illustrative, and the present disclosure is not limited thereto.

According to the exemplary embodiment of the present disclosure, the training dataset selection object 333 may include an object for displaying training dataset information related to the training of the model in the second output portion 340. For example, when the processor 110 receives a selection input for the training dataset selection object 333, the processor 110 may display training dataset information used in the training of the model, training dataset information used in the case where the trained model is retrained, new training dataset information newly added by the user, and the like in the second output portion 340. The foregoing matter is merely illustrative, and the present disclosure is not limited thereto.

According to the exemplary embodiment of the present disclosure, a training console selection object 335 may include an object for displaying information related to current training progress status information of the model in the second output portion. For example, when the processor 110 receives a selection input for the training console selection object, the processor 110 may display a current progress status of the training of the model (for example, information about the model to be trained, training progress rate, time remaining until completion of the training, the current CPU computation amount required for the training, the amount of memory used for the training) in the second output portion 340. The foregoing matter is merely illustrative, and the present disclosure is not limited thereto.

According to the exemplary embodiment of the present disclosure, the model archive selection object 337 may include an object for displaying information about at least one model in the second output portion. For example, when the processor 110 receives a selection input for the model archive selection object 337, the processor 110 may display a list of at least one model, detailed information about each model (for example, training completion time, and training dataset information used for training), and the like in the second output portion 340. The model archive may include a storage place in which the plurality of models is stored. The model archive may include, for example, a trained model, a non-trained model, a re-trained model, and the like. The processor 110 may receive an input signal of the user and call a model selected by the user from the model archive. The foregoing matter is merely illustrative, and the present disclosure is not limited thereto.

According to the exemplary embodiment of the present disclosure, the sensed anomaly output selection object 339 may include an object for displaying anomaly information sensed by using the model in the second output portion 340. For example, when the processor 110 receives an input signal for the sensed anomaly output selection object 339, the processor 110 may display information on anomaly data obtained by using the model in the second output portion 340. The foregoing matter is merely illustrative, and the present disclosure is not limited thereto.

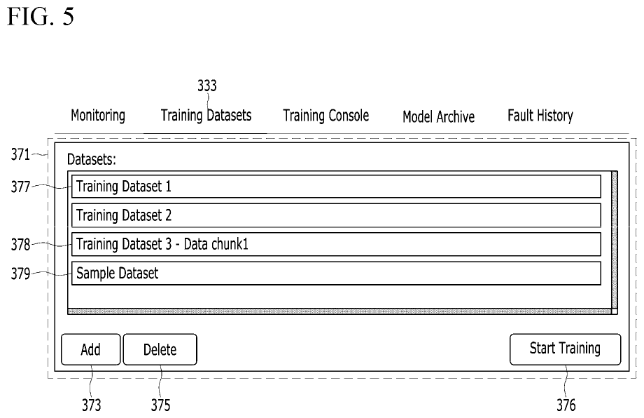

According to the exemplary embodiment of the present disclosure, the processor 110 may display a training dataset output screen in the second output portion. The processor 110 may receive an input signal for the training dataset selection object 333 and display the training dataset output screen 371 in the second output portion 340. The training dataset output screen will be described in detail with reference to FIG. 5.

According to the exemplary embodiment of the present disclosure, the processor 110 may display the training dataset output screen in the second output portion. The training dataset output screen may display training dataset-related information and an object for enabling the user to edit a training dataset list. The training dataset may include at least one piece of training data. The training data may include a predetermined type of data used for intelligence artificial training. For example, the training data may include image data, voice data, text data, natural language data, time series data, and the like. The foregoing matter is merely illustrative, and the present disclosure is not limited thereto.

According to the exemplary embodiment of the present disclosure, the training dataset output screen 371 may include at least one of a training dataset addition object 373 for receiving a training dataset list in which at least one training dataset is listed and a selection input for a training dataset to be used for training the model by the user, and a training dataset removal object 375 for receiving a selection input for a training dataset that is not to be used for training the model by the user. The training dataset list may include a list in which at least one training dataset is displayed in an aligned state. The training dataset alignment may be determined based on an input signal of the user. For example, the input signal of the user may be a signal that gives a high priority to a dataset used for the training of the model, and gives a low priority to data after relabeling misclassified data. In this case, the processor 110 may display the training dataset used for the training of the model in an upper portion of the training dataset list. Further, the training dataset list may include, for example, a training dataset selected according to the selection input of the user, a training dataset recommended by the processor 110, a newly added training dataset, and the like. The training dataset list may include, for example, training dataset 1 377 used for the training of the model, training dataset 3 378 including data chunk 1 after relabeling misclassified data, and a sample dataset 379 for estimating performance of the model. The sample dataset 379 may include a dataset input to the model in order to measure performance of the model when there is no training dataset. The training dataset addition object 373 may include an object for receiving a selection input for the training dataset to be used for training the model by the user. For example, when the processor 110 receives a selection input for the training dataset addition object 373, the processor 110 may newly display a screen for adding a training dataset. Further, the processor 110 may also display a pop-up window for adding a training dataset. The training dataset removal object 375 may include an object for receiving a selection input for a training dataset that is not to be used for training the model by the user. For example, when the processor 110 receives a selection input for the training dataset removal object 375 after receiving a selection input for a specific training dataset from the user, the processor 110 may remove the corresponding training dataset from the training dataset output screen 371. Accordingly, the removed training dataset may not be displayed in the screen of the user. The foregoing matter is merely illustrative, and the present disclosure is not limited thereto.

According to the exemplary embodiment of the present disclosure, the training dataset may include at least one training set. The training data may include a predetermined type of data used for artificial intelligence training. According to the exemplary embodiment of the present disclosure, the training dataset may include at least one of a first training dataset used for training the model and a new second training dataset to be used for retraining the model. The first training dataset may include the training dataset used in the training of the model. According to the exemplary embodiment of the present disclosure, the second training dataset may include a new training dataset to be used for retraining the model. The second training dataset may include at least a part of time series data obtained from the sensor in real time and a label corresponding to at least a part of the time series data. The label may include a value obtained by using a model (for example, a trained model performing auto labeling) automatically performing labelling or a value determined based on a selection input of the user. The label may also include a relabeled value for corresponding input data because a value obtained for the input data by using the trained model corresponds to misclassified data. The misclassified data may refer to data in which the results obtained using the model are misclassified. The misclassified data may be, for example, data that is classified as abnormal although a data subset is a normal data subset. When the processor 110 obtains a result that the corresponding data subset is anomaly by using the model, the corresponding data subset may be a misclassified data subset. The misclassified data subset may be corrected with a label by an operator or another model, and may be included in the training dataset by giving a modified label. The anomaly may be a part having an atypical pattern, not a normal pattern. The anomaly may include, for example, a part having a defectiveness of a product. The anomaly may also include a malfunctioning part of the motion (for example, a motion of a robot arm) of a machine. The foregoing matter is merely illustrative, and the present disclosure is not limited thereto.

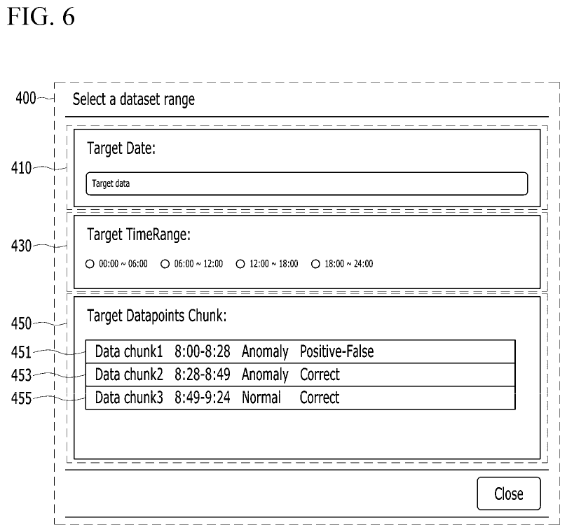

According to the exemplary embodiment of the present disclosure, the processor 110 may display the training dataset selection screen so that the user is capable of selecting the second training dataset. When the processor 110 receives a selection input for the training data addition object, the processor 110 may display the training data selection screen. Hereinafter, the training data selection screen will be described in detail with reference to FIG. 6.

According to the exemplary embodiment of the present disclosure, the training dataset selection screen 400 may include a screen for allowing the user to select the second training dataset. The processor 110 may display a screen for allowing the user to select the second training dataset required for improving performance of the model. Accordingly, the user may select the training dataset required for retraining the model through the displayed training dataset selection screen. The processor 110 may receive a selection input for the training dataset selected by the user. The processor 110 may train the model by inputting the selected training dataset to the model. Further, the training dataset selection screen 400 may include a screen for allowing the user to select a newly added training dataset (for example, a training dataset purchased from another company, a training dataset related to a new machine device, and data before and after a change of a recipe). The foregoing matter is merely illustrative, and the present disclosure is not limited thereto.

According to the exemplary embodiment of the present disclosure, the training dataset selection screen is the screen for allowing the user to select the second training dataset, and may include at least one of a time variable setting portion for filtering the data obtained by inputting the time series data to the model based on a predetermined first reference, and a data chunk portion 450 for displaying a data chunk in which data obtained by inputting the time series data to the model is divided based on a predetermined second reference. The second training dataset may include a new training dataset to be used for retraining the model. According to the exemplary embodiment of the present disclosure, the time variable setting portion may include a portion for filtering the data obtained by inputting the time series data to the model based on the predetermined first reference. The predetermined first reference may include a reference for a time. The predetermined first reference may include, for example, a period in the unit of year, month, day, hour, minute, and second. The processor 110 may display only data corresponding to an input period in the training dataset selection screen 400 based on the predetermined first reference input by the user. For example, when the input predetermined first reference is 00:00 to 24:00 on Oct. 30, 2019, the processor 110 may display only data corresponding to 00:00 to 24:00 on Oct. 30, 2019 in the training dataset selection screen 400. The time variable setting portion may include a period setting portion 410 for filtering data for a specific date or a time setting portion 430 for filtering data for a specific time on a specific date. For example, the processor 110 may receive a date of Oct. 30, 2019 through the period setting region 410, and receive a time of 6:00 to 12:00 through the time setting portion 430. In this case, the processor 110 may display data corresponding to 6:00 to 12:00 on Oct. 30, 2019 in the training dataset selection screen 400. In particular, the data displayed in the training dataset selection screen 400 may include data obtained by inputting time series data corresponding to 6:00 to 12:00 on Oct. 30, 2019 to the model. Through this, the processor 110 may selectively provide the user with data for a time zone requiring relabeling in order to improve the performance of the model. Accordingly, the user may set a time zone in which misclassified data exists and view only the data in the corresponding time zone through the selectively displayed screen. The foregoing matter is merely illustrative, and the present disclosure is not limited thereto.

According to the exemplary embodiment of the present disclosure, the data chunk portion 450 may include a portion for displaying a data chunk in which the data obtained by inputting the time series data to the model is divided based on the predetermined second reference. The data chunk may include a data subset that is at least a part of the dataset. The data chunk may include a part of the data in which the data obtained by inputting the time series data to the model is divided based on the predetermined second reference. The data chunk may be classified as representing a first state and/or a second state. The first state and the second state may refer to a binary classification result when the processor 110 performs binary classification by using the model. For example, the first state may represent normal and the second state may represent anomaly. The method of dividing the data obtained by inputting the time series data to the model based on the predetermined second reference by the processor 110 will be described in detail. The foregoing matter is merely illustrative, and the present disclosure is not limited thereto.

According to the exemplary embodiment of the present disclosure, the data chunk may include a statistical characteristic of each dataset obtained by inputting the plurality of pieces of the time series data divided based on the predetermined second reference to the model. The statistical characteristic is the characteristic representing a characteristic of the dataset through a statistical method, and may include a probability distribution, an average, a standard deviation, variance, and the like of the dataset. Accordingly, the data chunk may include probability distribution, an average, a standard deviation, variance, and the like of each dataset obtained by inputting the time series data to the model. For example, when the data chunk is divided at an interval of five minutes, the processor 110 may determine an average value of the dataset obtained by inputting each time series data subset divided at the interval of five minutes to the model as a statistical characteristic corresponding to the corresponding data chunk. Further, when the data chunk is divided based on the predetermined second reference, the processor 110 may also determine a median value of the dataset obtained by inputting the time series data subset divided based on the predetermined second reference to the model as a statistical characteristic corresponding to the corresponding data chunk. The processor 110 may display the statistical characteristic of the data chunk. The foregoing matter is merely illustrative, and the present disclosure is not limited thereto.

According to the exemplary embodiment of the present disclosure, the predetermined second reference may is the reference for detecting the misclassified data among the data obtained by using the model, and includes a reference based on which the data obtained by inputting the time series data to the model is divided into the plurality of data chunks based on at least one of a first point at which the data obtained by using the model is changed from the first state to the second state, a second point at which an output of the model is changed from the second state to the first state, a predetermined third point existing in the output of the model that is in the first state, and a predetermined fourth point existing in the output of the model that is in the second state. The first state and the second state may refer to the binary classification results when the processor 110 performs binary classification by using the model. For example, the first state may represent normal and the second state may represent anomaly. The processor 110 may determine the reference based on which the data chunk is divided with the first point and/or the second point. Accordingly, the processor 110 may determine the first point at which the obtained data is changed from the first state to the second state as a start point of the data chunk. In this case, the processor 110 may determine the second point at which the obtained data is changed from the second state to the first state as a termination point of the corresponding data chunk. In the contrast, the processor 110 may determine the second point at which the obtained data is changed from the second state to the first state as a start point of the data chunk. In this case, the processor 110 may also determine the first point at which the obtained data is changed from the first state to the second state as a termination point of the corresponding data chunk. Accordingly, the processor 110 may classify the data chunk in which the output of the model is normal and the data chunk in which the output of the model is anomaly.

According to another exemplary embodiment of the present disclosure, the predetermined second reference may include a reference based on which the data obtained by inputting the time series data to the model is divided into the plurality of data chunks based on a predetermined third point existing in the output of the model that is in the first state. According to the exemplary embodiment of the present disclosure, the first state may represent normal and the second state may represent anomaly. The third point may include a point for dividing the normal output of the model into at least one data chunks. The processor 110 may divide the normal output of the model into the plurality of data chunks based on the predetermined third point existing in the normal output of the model. For example, the processor 110 may determine the third point as a start point and another third point as a termination point. Accordingly, the processor 110 may obtain subdivided data chunks even for the normal output of the model. For another example, the processor 110 may determine the first point as a start point and the third point as a termination point. The processor 110 may determine the second point as a start point and another third point as a termination point. The processor 110 may determine the third point as a start point and the first point and/or the second point as a termination point. The foregoing matter is merely illustrative, and the present disclosure is not limited thereto.

According to another exemplary embodiment of the present disclosure, the predetermined second reference may include a reference based on which the data obtained by inputting the time series data to the model is divided into the plurality of data chunks based on a predetermined fourth point existing in the output of the model that is in the second state. According to the exemplary embodiment of the present disclosure, the first state may represent normal and the second state may represent anomaly. A fourth point may include a point for dividing the anomaly output of the model into at least one data chunks. The processor 110 may divide the anomaly output of the model into the plurality of data chunks based on the predetermined fourth point existing in the anomaly output of the model. For example, the processor 110 may determine the fourth point as a start point and another fourth point as a termination point. Accordingly, the processor 110 may obtain subdivided data chunks even for the anomaly output of the model. For another example, the processor 110 may determine the first point as a start point and the fourth point as a termination point. The processor 110 may determine the second point as a start point and the fourth point as a termination point. The processor 110 may determine the third point as a start point and the fourth point as a termination point. The processor 110 may determine the fourth point as a start point and the first point, the second point, and/or the third point as a termination point. The foregoing matter is merely illustrative, and the present disclosure is not limited thereto.

Accordingly, the processor 110 may display the data chunk for each classification result in the data chunk portion 450. The user may view the displayed data chunk and determine which data chunk is the misclassified data. For example, as illustrated in FIG. 6, in the data chunk portion 450, a data chunk 1 451, a data chunk 2 453, and a data chunk 3 455 may be displayed. Herein, the data chunk 1 451 may be the misclassified data (For example, false positive—the case where the obtained data is the normal data, but the output obtained by using the model is anomaly). That is, when the prediction of the model is wrong, the processor 110 may receive an input signal from the user and relabel the misclassified data chunk. That is, when the obtained data is the normal data, but the output obtained by using the model is anomaly, the processor 110 may relabel the corresponding data as normal. The processor 110 may retrain the model by inputting the relabeled data chunk to the model. Accordingly, the processor 110 may update the model for a part that the model incorrectly predicts. Through the update process, accuracy of the prediction by the model may be ultimately improved. In the case of the data chunk 3 455, a result value obtained by using the model may be normal. Further, the input data may also be normal. In this case, the data chunk 3 455 may be an accurately predicted and/or classified dataset. Accordingly, for the data chunk 3, a need for retraining the model by inputting the data to the model again may be decreased. In this case, the processor 110 may not relabel the data chunk 3. The foregoing matter is merely illustrative, and the present disclosure is not limited thereto.

According to the exemplary embodiment of the present disclosure, the data chunk may include at least one of a data chunk including a data chunk calculated through a data chunk recommendation algorithm that recommends a data chunk to be used for retraining the model to the user, at least one data chunk having a similar statistical characteristic to that of the data chunk selected according to the reception of a selection input signal of the user. The data chunk recommendation algorithm may include an algorithm for recommending a data chunk to be used for retraining the model to the user. In particular, the data chunk recommendation algorithm may include an algorithm for recommending a data chunk required for improving performance of the model. The data chunk recommendation algorithm may include, for example, an algorithm for recommending a misclassified data chunk, and an algorithm for outputting information on a time at which misclassified data occurs the most. The processor 110 may automatically detect and display a misclassified data chunk. Further, the processor 110 may also display a data chunk in a time zone in which misclassified data occurs the most. Accordingly, the processor 110 displays the data chunk calculated through the data chunk recommendation algorithm, thereby helping the user to rapidly find the data required for retraining the model. Accordingly, the user selectively views the data or the dataset required for retraining the model, thereby quickly making a decision required for retraining the model. The foregoing matter is merely illustrative, and the present disclosure is not limited thereto.

According to the exemplary embodiment of the present disclosure, the data chunk may include at least one data chunk having a similar statistical characteristic to that of the data chunk selected according to the reception of a selection input signal of the user. The processor 110 may display a data chunk having a similar statistical characteristic (for example, a similar average value, a similar probability distribution, and similar variance) to that of the data chunk selected according to the reception of the selection input of the user. Accordingly, when the user receives a selection input for the misclassified data chunk selected by the user, the processor 110 displays the data chunk having the similar statistical characteristic to that of the corresponding data chunk, thereby enabling the user to quickly view the data required for retraining the model. Accordingly, the processor 110 displays the data chunk calculated through the recommendation algorithm and/or the data chunk having the similar statistical characteristic to that of the data chunk selected according to the reception of the selection input of the user in the data chunk portion 450, so that the user may easily recognize a dataset that may be required for retraining the model at a glance. That is, the data chunk having the similar statistical characteristic to that of the misclassified data may be more likely to be the misclassified data. Accordingly, the processor 110 may selectively display only the data chunks that are likely to be the misclassified data by displaying the data chunk having the similar statistical characteristic to that of the data chunk. The foregoing matter is merely illustrative, and the present disclosure is not limited thereto.

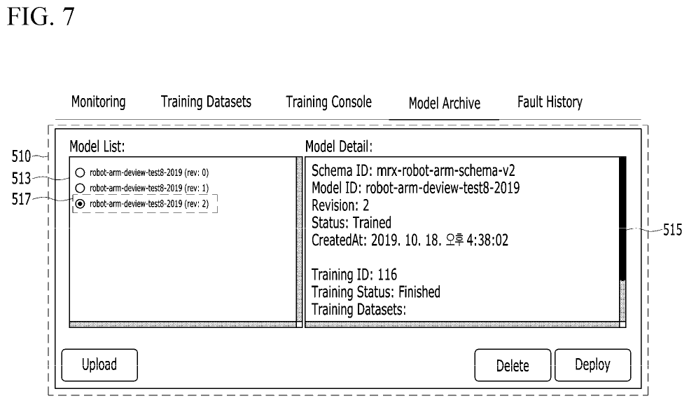

According to the exemplary embodiment of the present disclosure, the processor 110 may display a model archive output screen in the second output portion. The processor 110 may receive an input signal for the model archive selection object 337 and display the model archive output screen 510 in the second output portion 340. The model archive output screen will be described in detail with reference to FIG. 7.

According to the exemplary embodiment of the present disclosure, the model archive output screen 510 may include a screen for displaying information about each of the plurality of models. The model archive output screen 510 may include at least one of a model list output portion 513 for displaying the plurality of models stored in the model archive so that the user views the plurality of models, and a model information output portion 515 for displaying information about a model selected according to the reception of a selection input signal of the user. The model archive may include a storage place in which the plurality of models is stored. The model archive may include, for example, a trained model, a non-trained model, and a retrained model. The processor 110 may receive an input signal of the user and call a model selected by the user from the model archive. According to the exemplary embodiment of the present disclosure, the model list output portion 513 may include a portion for displaying the plurality of models stored in the model archive so that the user views the plurality of models at a glance. The model list output portion 513 may include a portion for displaying the models selected based on the selection input of the user so that the user views the models at a glance. For example, the model list output portion 513 may include a model included in a project, a model selected by the user, a model recommended to the user, and the like. According to the exemplary embodiment of the present disclosure, the model information output portion 515 may include a portion for displaying information about a model selected according to the reception of the selection input signal of the user. The model information output portion 515 may include a portion in which, for example, a model name, a model state (for example, before training, after training, and during training), a model generation date, and information about the training dataset used for training the model) are displayed. The foregoing matter is merely illustrative, and the present disclosure is not limited thereto.

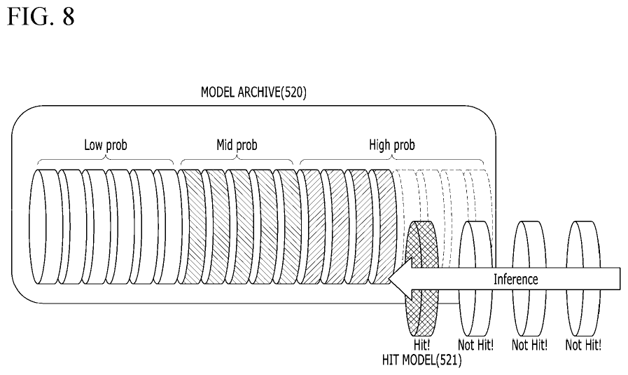

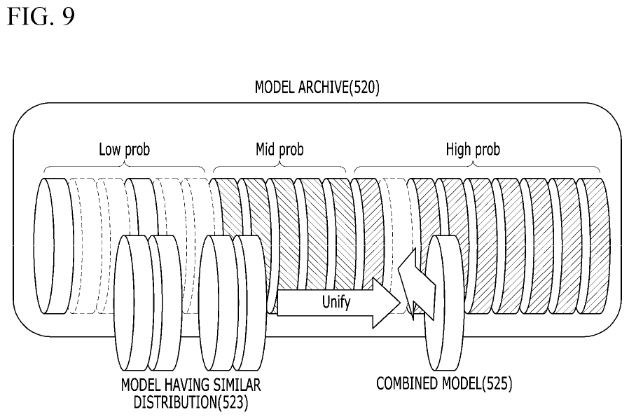

The models included in the model list will be described in detail with reference to FIGS. 8 and 9.

According to the exemplary embodiment of the present disclosure, the model list may include at least one of a model trained while progressing the project, a model 517 retrained by inputting the second training dataset to the trained model, a model 525 newly generated by combining the models having the similar statistical characteristic among the plurality of models included in the model archive, and a model 521 determined based on a hit rate of each of the plurality of models included in the model archive in order to recommend the model corresponding to the newly input data to the user. The foregoing matter is merely illustrative, and the present disclosure is not limited thereto. The anomaly detection in multiple normal state environments using a plurality of models is discussed in detail in Korean Patent Application No. 10-2018-0080482 (Jul. 11, 2018) the entirety of which is incorporated as a reference in the present specification.

According to the exemplary embodiment of the present disclosure, FIG. 8 illustrates a model archive 520 and a hit model 521. The hit model 521 may include a model determined based on a hit rate of each of the plurality of models included in the model archive in order to recommend the model corresponding to the newly input data to the user. The hit rate may include a probability that the input data is determined (for example, a final determination) as normal or abnormal by the corresponding model. For the newly input time series data, the user may not know which model outputs an optimum result. Further, when the performance of the models is compared by inputting the newly input time series data to all of the models included in the model archive, lots of time and cost may be consumed. Accordingly, for the newly input time series data, the processor 110 may select a model having a high probability of hitting among the models stored in the model archive 520 and display the selected model. Through this, the user may quickly obtain an appropriate model for the newly input data without going through an experimental process. The foregoing matter is merely illustrative, and the present disclosure is not limited thereto.

According to the exemplary embodiment of the present disclosure, FIG. 9 illustrates the model archive 520, models 523 having a similar distribution, and a combined model 525. The processor 110 may combine the models 523 having the similar distribution and newly generate the combined model 525. That is, the processor 110 may also generate a model having a high probability of being used for the newly input data by combining one or more models having a low probability of being used for the newly input data. Through this, the processor 110 may also quickly calculate an appropriate model for the newly input data by selectively calculating a hit rate for each of the models included in the group having the high probability of being used. The foregoing matter is merely illustrative, and the present disclosure is not limited thereto.

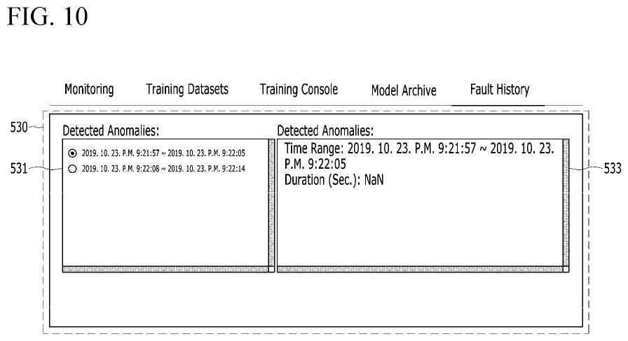

According to the exemplary embodiment of the present disclosure, the processor 110 may display the sensed anomaly output screen in the second output portion. The processor 110 may receive an input signal for the sensed anomaly output selection object 339 and display the sensed anomaly output screen 530 in the second output portion 340. The sensed anomaly output screen will be described in detail with reference to FIG. 10.

According to the exemplary embodiment of the present disclosure, the processor 110 may display the sensed anomaly output screen 530 in the second output portion. The sensed anomaly output screen 530 may include an anomaly detection result output portion for displaying an anomaly detection result obtained by using the model.

According to the exemplary embodiment of the present disclosure, the sensed anomaly output screen 530 may include a screen for displaying information related to anomaly data among the data obtained by using the model. The sensed anomaly output screen 530 may include at least one of an anomaly detection result output portion 531 for displaying a list of the anomaly data obtained by using the model, and an anomaly information output portion 533 for displaying information about the anomaly data selected according to the reception of the selection input signal of the user. The anomaly detection result output portion 531 may include a portion for displaying a list of the anomaly data obtained by using the model. For example, the processor 110 may display the data classified as anomaly among the data obtained by using the model in the anomaly detection result output portion 531. The anomaly information output portion 533 may include a portion for displaying information about the anomaly data selected according to the reception of the selection input signal of the user. For example, the processor 110 may display information about the anomaly data selected according to the selection input signal of the user, that is, a start time at which anomaly occurs, an end time at which anomaly ends, and a period in which anomaly occurs. The foregoing matter is merely illustrative, and the present disclosure is not limited thereto.

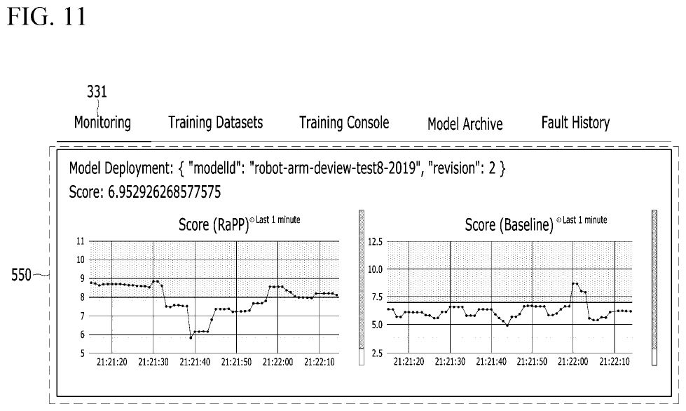

According to the exemplary embodiment of the present disclosure, the processor 110 may display a model performance output screen in the second output portion. The processor 110 may receive an input signal for the performance monitoring selection object 331 and display the model performance output screen 550 in the second output portion 340. The model performance output screen will be described in detail with reference to FIG. 11.

According to the exemplary embodiment of the present disclosure, as illustrated in FIG. 11, the processor 110 may display the model performance output screen 550 in the second output portion. The model performance output screen 550 may include a screen for displaying performance information of the model. The performance information of the model may include all of the information related to the performance of the model. For example, the performance information of the model may include a measure of how accurate the model outputs a prediction result value for the input data. Further, the performance information of the model may include a prediction value which the processor 110 obtains by using the model. The foregoing matter is merely illustrative, and the present disclosure is not limited thereto.

According to the present disclosure, the present disclosure provides the user interface for training the model, thereby helping people who do not have expert knowledge for the artificial intelligence field to retrain the model for a part where abnormality occurs. Through this, even people who do not have expert knowledge for the artificial intelligence field may maintain and repair the model or retrain the model by inputting new data to the model. Accordingly, experts of various domains using models (for example, manufacturing business, medical treatment, legal business, administration, and finance) may directly discover problems themselves and update the model with their own expertise in order to improve the models. Accordingly, through the present disclosure, a process using the deep learning model is simplified and only the required information is selectively output, thereby increasing a speed of expansion and application of the deep learning technology to the various technology domains.

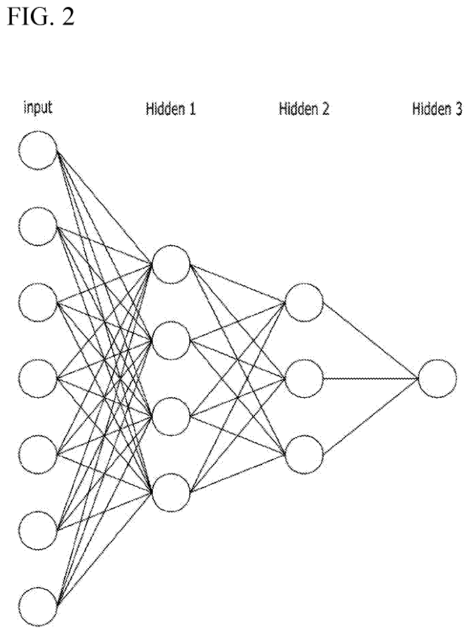

FIG. 2 is a diagram illustrating an example of a neural network that is a target for training in the method of training the neural network according to the exemplary embodiment of the present disclosure.

Throughout the present specification, a computation model, a neural network, a network function, and a neural network may be used as the same meaning. The neural network may consist of a set of interconnected computational units, which may generally be referred to as “nodes”. The “nodes” may also be called “neurons”. The neural network consists of one or more nodes. The nodes (or neurons) configuring the neural network may be interconnected by one or more “links”.

In the neural network, one or more nodes connected through the links may relatively form a relationship of an input node and an output node. The concept of the input node is relative to the concept of the output node, and a predetermined node having an output node relationship with respect to one node may have an input node relationship in a relationship with another node, and a reverse relationship is also available. As described above, the relationship between the input node and the output node may be generated based on the link. One or more output nodes may be connected to one input node through a link, and a reverse case may also be valid.

In the relationship between an input node and an output node connected through one link, a value of the output node may be determined based on data input to the input node. Herein, a node connecting the input node and the output node may have a parameter. The parameter is variable, and in order for the neural network to perform a desired function, the parameter may be varied by a user or an algorithm. For example, when one or more input nodes are connected to one output node by links, respectively, a value of the output node may be determined based on values input to the input nodes connected to the output node and a parameter set in the link corresponding to each of the input nodes.

As described above, in the neural network, one or more nodes are connected with each other through one or more links to form a relationship of an input node and an output node in the neural network. A characteristic of the neural network may be determined according to the number of nodes and links in the neural network, a correlation between the nodes and the links, and a value of the parameter assigned to each of the links. For example, when there are two neural networks in which the numbers of nodes and links are the same and the parameter values between the links are different, the two neural networks may be recognized to be different from each other.

The neural network may consist of one or more nodes. Some of the nodes configuring the neural network may form one layer based on distances from an initial input node. For example, a set of nodes having a distance of n from an initial input node may form n layers. The distance from the initial input node may be defined by the minimum number of links, which needs to be passed from the initial input node to a corresponding node. However, the definition of the layer is arbitrary for the description, and a degree of the layer in the neural network may be defined by a different method from the foregoing method. For example, the layers of the nodes may be defined by a distance from a final output node.

The initial input node may mean one or more nodes to which data is directly input without passing through a link in a relationship with other nodes among the nodes in the neural network. Otherwise, the initial input node may mean nodes which do not have other input nodes connected through the links in a relationship between the nodes based on the link in the neural network. Similarly, the final output node may mean one or more nodes which do not have an output node in a relationship with other nodes among the nodes in the neural network. Further, the hidden node may mean nodes configuring the neural network, not the initial input node and the final output node. In the neural network according to the exemplary embodiment of the present disclosure, the number of nodes of the input layer may be the same as the number of nodes of the output layer, and the neural network may be in the form that the number of nodes decreases and then increases again from the input layer to the hidden layer. Further, in the neural network according to another exemplary embodiment of the present disclosure, the number of nodes of the input layer may be smaller than the number of nodes of the output layer, and the neural network may be in the form that the number of nodes decreases from the input layer to the hidden layer. Further, in the neural network according to another exemplary embodiment of the present disclosure, the number of nodes of the input layer may be larger than the number of nodes of the output layer, and the neural network may be in the form that the number of nodes increases from the input layer to the hidden layer. The neural network according to another exemplary embodiment of the present disclosure may be the neural network in the form in which the foregoing neural networks are combined.

A deep neural network (DNN) may mean the neural network including a plurality of hidden layers, in addition to an input layer and an output layer. When the DNN is used, it is possible to recognize a latent structure of data. That is, it is possible to recognize the latent structures of pictures, texts, videos, voices, and music (for example, an object included in the picture, the contents and the emotion of the text, and the contents and the emotion of the voice). The DNN may include a convolutional neural network (CNN), a recurrent neural network (RNN), an auto encoder, Generative Adversarial Networks (GAN), a restricted Boltzmann machine (RBM), a deep belief network (DBN), a Q network, a U network Siamese network, and the like. The foregoing description of the deep neural network is merely illustrative, and the present disclosure is not limited thereto.

In the exemplary embodiment of the present disclosure, the network function may include an auto encoder. The auto encoder may be one type of artificial neural network for outputting output data similar to input data. The auto encoder may include at least one hidden layer, and the odd-numbered hidden layers may be disposed between the input/output layers. The number of nodes of each layer may decrease from the number of nodes of the input layer to an intermediate layer called a bottleneck layer (encoding), and then be expanded symmetrically with the decrease from the bottleneck layer to the output layer (symmetric with the input layer). The nodes of a dimension reduction layer may or may not be symmetrical to the nodes of a dimension restoration layer. The auto encoder may perform a nonlinear dimension reduction. The number of input layers and the number of output layers may correspond to the number of sensors left after preprocessing of the input data. In the auto encoder structure, the number of nodes of the hidden layer included in the encoder decreases as a distance from the input layer increases. When the number of nodes of the bottleneck layer (the layer having the smallest number of nodes located between the encoder and the decoder) is too small, the sufficient amount of information may not be transmitted, so that the number of nodes of the bottleneck layer may be maintained in a specific number or more (for example, a half or more of the number of nodes of the input layer and the like).

The neural network may be learned by at least one scheme of supervised learning, unsupervised learning, and semi-supervised learning. The learning of the neural network is for the purpose of minimizing an error of an output. In the learning of the neural network, training data is repeatedly input to the neural network and an error of an output of the neural network for the training data and a target is calculated, and the error of the neural network is back-propagated in a direction from an output layer to an input layer of the neural network in order to decrease the error, and a parameter of each node of the neural network is updated. In the case of the supervised learning, training data labelled with a correct answer (that is, labelled training data) is used, in each training data, and in the case of the unsupervised learning, a correct answer may not be labelled to each training data. That is, for example, the training data in the supervised learning for data classification may be data, in which category is labelled to each of the training data. The labelled training data is input to the neural network and the output (category) of the neural network is compared with the label of the training data to calculate an error. For another example, in the case of the unsupervised learning related to the data classification, training data that is the input is compared with an output of the neural network, so that an error may be calculated. The calculated error is back-propagated in a reverse direction (that is, the direction from the output layer to the input layer) in the neural network, and a parameter of each of the nodes of the layers of the neural network may be updated according to the backpropagation. A variation rate of the updated parameter of each node may be determined according to a learning rate. The calculation of the neural network for the input data and the backpropagation of the error may configure a learning epoch. The learning rate is differently applicable according to the number of times of repetition of the learning epoch of the neural network. For example, at the initial stage of the learning of the neural network, a high learning rate is used to make the neural network rapidly secure performance of a predetermined level and improve efficiency, and at the latter stage of the learning, a low learning rate is used to improve accuracy.

In the learning of the neural network, the training data may be generally a subset of actual data (that is, data to be processed by using the learned neural network), and thus an error for the training data is decreased, but there may exist a learning epoch, in which an error for the actual data is increased. Overfitting is a phenomenon, in which the neural network excessively learns training data, so that an error for actual data is increased. For example, a phenomenon, in which the neural network learning a cat while seeing a yellow cat cannot recognize cats, other than a yellow cat, as cats, is a sort of overfitting. Overfitting may act as a reason of increasing an error of a machine learning algorithm. In order to prevent overfitting, various optimizing methods may be used. In order to prevent overfitting, a method of increasing training data, a regularization method, a dropout method of omitting a part of nodes of the network during the learning process, and the like may be applied.

According to the exemplary embodiment of the present disclosure, a computer readable medium storing a data structure is disclosed.

The data structure may refer to organization, management, and storage of data that enable efficient access and modification of data. The data structure may refer to organization of data for solving a specific problem (for example, data search, data storage, and data modification in the shortest time). The data structure may also be defined with a physical or logical relationship between the data elements designed to support a specific data processing function. The logical relationship between the data elements may include a connection relationship between the data elements that the user thinks. The physical relationship between the data elements may include an actual relationship between the data elements physically stored in a computer readable storage medium (for example, a hard disk). In particular, the data structure may include a set of data, a relationship between data, and a function or a command applicable to data. Through the effectively designed data structure, the computing device may perform a computation while minimally using resources of the computing device. In particular, the computing device may improve efficiency of computation, reading, insertion, deletion, comparison, exchange, and search through the effectively designed data structure.

The data structure may be divided into a linear data structure and a non-linear data structure according to the form of the data structure. The linear data structure may be the structure in which only one data is connected after one data. The linear data structure may include a list, a stack, a queue, and a deque. The list may mean a series of dataset in which order exists internally. The list may include a linked list. The linked list may have a data structure in which each data has a pointer and is linked in a single line. In the linked list, the pointer may include information about the connection with the next or previous data. The linked list may be expressed as a single linked list, a double linked list, and a circular linked list according to the form. The stack may have a data listing structure with limited access to data. The stack may have a linear data structure that may process (for example, insert or delete) data only at one end of the data structure. The data stored in the stack may have a data structure (Last In First Out, LIFO) in which the later the data enters, the sooner the data comes out. The queue is a data listing structure with limited access to data, and may have a data structure (First In First Out, FIFO) in which the later the data is stored, the later the data comes out, unlike the stack. The deque may have a data structure that may process data at both ends of the data structure.

The non-linear data structure may be the structure in which the plurality of pieces of data is connected after one data. The non-linear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

Throughout the present specification, a computation model, the nerve network, the network function, and the neural network may be used with the same meaning (hereinafter, the present disclosure will be described based on the unification to the neural network). The data structure may include a neural network. Further, the data structure including the neural network may be stored in a computer readable medium. The data structure including the neural network may also include data input to the neural network, a weight of the neural network, a hyper-parameter of the neural network, data obtained from the neural network, an active function associated with each node or layer of the neural network, and a loss function for training of the neural network. The data structure including the neural network may include predetermined configuration elements among the disclosed configurations. That is, the data structure including the neural network may be formed of the entirety or a predetermined combination of data input to the neural network, a weight of the neural network, a hyper-parameter of the neural network, data obtained from the neural network, an active function associated with each node or layer of the neural network, and a loss function for training of the neural network. In addition to the foregoing configurations, the data structure including the neural network may include predetermined other information determining a characteristic of the neural network. Further, the data structure may include all type of data used or generated in a computation process of the neural network, and is not limited to the foregoing matter. The computer readable medium may include a computer readable recording medium and/or a computer readable transmission medium. The neural network may be formed of a set of interconnected calculation units which are generally referred to as “nodes”. The “nodes” may also be called “neurons”. The neural network consists of one or more nodes.

The data structure may include data input to the neural network. The data structure including the data input to the neural network may be stored in the computer readable medium. The data input to the neural network may include training data input in the training process of the neural network and/or input data input to the training completed neural network. The data input to the neural network may include data that has undergone pre-processing and/or data to be pre-processed. The pre-processing may include a data processing process for inputting data to the neural network. Accordingly, the data structure may include data to be pre-processed and data generated by the pre-processing. The foregoing data structure is merely an example, and the present disclosure is not limited thereto.

The data structure may include data input to the neural network or output from the neural network. The data structure including the data input to or output from the neural network may be stored in the computer readable medium. The data structure stored in the computer readable medium may include data input in an inference process of the neural network or output data output as a result of the interference of the neural network. Further, the data structure may include data processed by a specific data processing method, so that the data structure may include data before and after processing. Accordingly, the data structure may include data to be processed and data processed through the data processing method.

The data structure may include a weight of the neural network (in the present specification, a weight and a parameter may be used as the same meaning). Further, the data structure including the weight of the neural network may be stored in the computer readable medium. The neural network may include a plurality of weights. The weight is variable, and in order for the neural network to perform a desired function, the weight may be varied by a user or an algorithm. For example, when one or more input nodes are connected to one output node by links, respectively, a value of the output node may be determined based on values input to the input nodes connected to the output node and the parameter set in the link corresponding to each of the input nodes. The foregoing data structure is merely an example, and the present disclosure is not limited thereto.

For a non-limited example, the weight may include a weight varied in the neural network training process and/or the weight of the training completed neural network. The weight varied in the neural network training process may include a weight at a time at which a training cycle starts and/or a weight varied during a training cycle. The weight of the training completed neural network may include a weight of the neural network completing the training cycle. Accordingly, the data structure including the weight of the neural network may include the data structure including the weight varied in the neural network training process and/or the weight of the training completed neural network. Accordingly, it is assumed that the weight and/or a combination of the respective weights are included in the data structure including the weight of the neural network. The foregoing data structure is merely an example, and the present disclosure is not limited thereto.

The data structure including the weight of the neural network may be stored in the computer readable storage medium (for example, a memory and a hard disk) after undergoing a serialization process. The serialization may be the process of storing the data structure in the same or different computing devices and converting the data structure into a form that may be reconstructed and used later. The computing device may serialize the data structure and transceive the data through a network. The serialized data structure including the weight of the neural network may be reconstructed in the same or different computing devices through deserialization. The data structure including the weight of the neural network is not limited to the serialization. Further, the data structure including the weight of the neural network may include a data structure (for example, in the non-linear data structure, B-Tree, Trie, m-way search tree, AVL tree, and Red-Black Tree) for improving efficiency of the computation while minimally using the resources of the computing device. The foregoing matter is merely illustrative, and the present disclosure is not limited thereto.

The data structure may include a hyper-parameter of the neural network. The data structure including the hyper-parameter of the neural network may be stored in the computer readable medium. The hyper-parameter may be a variable varied by a user. The hyper-parameter may include, for example, a learning rate, a cost function, the number of times of repetition of the training cycle, weight initialization (for example, setting of a range of a weight to be weight-initialized), and the number of hidden units (for example, the number of hidden layers and the number of nodes of the hidden layer). The foregoing data structure is merely an example, and the present disclosure is not limited thereto.

FIG. 3 is a diagram illustrating an example of a first screen according to the exemplary embodiment of the present disclosure.

According to the exemplary embodiment of the present disclosure, the computing device 100 may display the first screen 200 including at least one first object 230 for receiving a selection input for the project. The project 210 may include a project related to artificial intelligence for achieving a specific goal by using artificial intelligence. In particular, the project 210 may include a project related to deep learning for achieving a specific goal by using deep learning. The first object 230 may include an object for selecting the project 210. The first object 230 may include a function of moving to a second screen for the selected project 210. The first object 230 may include, for example, an icon in the screen. The first screen 200 may be the screen on which at least one project conducted by a user is displayed. The first screen 200 may include a screen for displaying a plurality of projects conducted by the user so that the user easily sees the plurality of projects at a glance. The selection input may include an input signal including information on an item selected by the user. Accordingly, when the computing device 100 receives the selection input, the computing device 100 may perform a computation based on the corresponding selection or display a result for the selection input on the screen. The foregoing matter is merely illustrative, and the present disclosure is not limited thereto.

According to the exemplary embodiment of the present disclosure, the project 210 may include an artificial intelligence-related project for achieving a specific goal by using the artificial intelligence. The specific goal may include a goal for improving performance of a model to which the artificial intelligence is applied. The specific goal may include, for example, improvement of accuracy of prediction of the model, a decrease in a training time of the model, and a decrease in the amount of computation or the amount of power used in training the model. Further, the specific goal may also include a goal for generating a model for obtaining a prediction value (for example, a stock price prediction in the case of finance) in a specific domain (for example, manufacturing business, medical treatment, legal business, administration, and finance). The foregoing matter is merely illustrative, and the present disclosure is not limited thereto.

According to the exemplary embodiment of the present disclosure, the computing device 100 may display the second screen for displaying project-related information corresponding to the selected project. The second screen may include a screen for displaying project-related information corresponding to the corresponding selection input by the computing device 100 according to the reception of the selection input of the first screen. The foregoing matter is merely illustrative, and the present disclosure is not limited thereto.

FIG. 4 is a diagram illustrating an example of the second screen according to the exemplary embodiment of the present disclosure.

According to the exemplary embodiment of the present disclosure, the computing device 100 may display the second screen 300 for displaying project-related information corresponding to the selected project. The second screen 300 may include a screen for displaying information about a specific project. The second screen 300 may include a screen for displaying information required for improving performance of the deep learning model by the user. The second screen 300 may include, for example, a user interface in which information for improving performance of the deep learning model is displayed. Accordingly, the second screen 300 may include information on performance of the model, information on a training dataset used in training the model, a prediction value output by using the model by the computing device 100, and the like. The foregoing matter is merely illustrative, and the present disclosure is not limited thereto.

According to the exemplary embodiment of the present disclosure, the second screen may include at least one of a first output portion 310 for displaying time series data obtained from a sensor, a selection portion 330 including at least one second object for receiving a selection input related to a model retraining, and a second output portion 340 for displaying information corresponding to the second object. The first output portion 310 may include a portion for displaying time series data obtained from the sensor. For example, the first output portion 310 may include a portion for displaying time series data obtained from the sensor in real time. The time series data obtained from the sensor may include, for example, time series data obtained from a sensor attached to a joint of a robot, time series data obtained from a material measuring sensor, temperature data, wind direction and wind speed data, ultraviolet sensor data, infrared sensor data, light sensor data, and sound sensor data. The second output portion 340 may include a portion for displaying information corresponding to the second object. The computing device 100 may receive a selection input for the second object and display information corresponding to the second object. For example, when the computing device 100 receives the selection input for the second object (for example, a training data selection icon), the computing device 100 may display information related to the training data in the second output portion 340. The selection portion may include a portion including at least one second object for receiving a selection input related to the re-training of the model. The selection portion 330 may be a portion including an object for displaying information related to the training of the model in the second output portion. For example, the selection portion 330 may include a plurality of icons in the user interface so that the user may see desired information related to the re-training of the model through the second output portion. The foregoing matter is merely illustrative, and the present disclosure is not limited thereto.

According to the exemplary embodiment of the present disclosure, the selection portion is a portion including an object for displaying the information related to the training of the model in the second output portion, and may include at least one of a performance monitoring selection object 331 for displaying performance information of the model in the second output portion, a training dataset selection object 333 for displaying training dataset information related to the training of the model in the second output portion, a model archive selection object 337 for displaying information about at least one model in the second output portion, and a sensed anomaly output selection object 339 for displaying information on anomaly sensed by using the model in the second output portion. The foregoing matter is merely illustrative, and the present disclosure is not limited thereto.

According to the exemplary embodiment of the present disclosure, the performance monitoring selection object 331 may include an object for displaying performance information of the model in the second output portion. For example, when the computing device 100 receives a selection input for the performance monitoring selection object 331, the computing device 100 may display model performance information (for example, accuracy of the prediction by the model) in the second output portion. The foregoing matter is merely illustrative, and the present disclosure is not limited thereto.

According to the exemplary embodiment of the present disclosure, the training dataset selection object 333 may include an object for displaying training dataset information related to the training of the model in the second output portion 340. For example, when the computing device 100 receives a selection input for the training dataset selection object 333, the computing device 100 may display training dataset information used in the training of the model, training dataset information used in the case where the trained model is retrained, new training dataset information newly added by the user, and the like in the second output portion 340. The foregoing matter is merely illustrative, and the present disclosure is not limited thereto.

According to the exemplary embodiment of the present disclosure, a training console selection object 335 may include an object for displaying information about current training progress status of the model in the second output portion. For example, when the computing device 100 receives a selection input for the training console selection object 335, the computing device 100 may display a current progress status of the training of the model (for example, information about the model to be trained, training progress rate, time remaining until completion of the training, the current CPU computation amount required for the training) in the second output portion 340. The foregoing matter is merely illustrative, and the present disclosure is not limited thereto.

According to the exemplary embodiment of the present disclosure, the model archive selection object 337 may include an object for displaying information about at least one model in the second output portion. For example, when the computing device 100 receives a selection input for the model archive selection object 337, the computing device 100 may display a list of at least one model, detailed information about each model (for example, training completion time, and training dataset information used for training), and the like in the second output portion 340. The model archive may include a storage place in which the plurality of models is stored. The model archive may include, for example, a trained model, a non-trained model, a re-trained model, and the like. The computing device 100 may receive an input signal of the user and call a model selected by the user from the model archive. The foregoing matter is merely illustrative, and the present disclosure is not limited thereto.

According to the exemplary embodiment of the present disclosure, the sensed anomaly output selection object 339 may include an object for displaying anomaly information sensed by using the model in the second output portion 340. For example, when the computing device 100 receives an input signal for the sensed anomaly output selection object 339, the computing device 100 may display information on anomaly data obtained by using the model in the second output portion 340. The foregoing matter is merely illustrative, and the present disclosure is not limited thereto.

FIG. 5 is a diagram illustrating an example of a training dataset output screen according to the exemplary embodiment of the present disclosure.

According to the exemplary embodiment of the present disclosure, the computing device 100 may display a training dataset output screen in the second output portion. The computing device 100 may receive an input signal for the training dataset selection object 333 and display the training dataset output screen 371 in the second output portion 340.

According to the exemplary embodiment of the present disclosure, the computing device 100 may display the training dataset output screen in the second output portion. The training dataset output screen may display an object for displaying training dataset-related information and editing a training dataset list. The training dataset may include at least one piece of training data. The training data may include a predetermined type of data used for intelligence artificial training. For example, the training data may include image data, voice data, text data, natural language data, time series data, and the like. The foregoing matter is merely illustrative, and the present disclosure is not limited thereto.

According to the exemplary embodiment of the present disclosure, the training dataset output screen 371 may include at least one of a training dataset addition object 373 for receiving a training dataset list in which at least one training dataset is listed and a selection input for a training dataset to be used for training the model by the user, and a training dataset removal object 375 for receiving a selection input for a training dataset that is not to be used for training the model by the user. The training dataset list may include a list in which at least one training dataset is displayed in an aligned state. The training dataset list may include, for example, a training dataset selected according to the selection input of the user, a training dataset recommended by the computing device 100, a newly added training dataset, and the like. The training dataset list may include, for example, training dataset 1 377 used for the training of the model, training dataset 3 378 including data chunk 1 after relabeling misclassified data, and a sample dataset 379 for estimating performance of the model. The sample dataset 379 may include a dataset input to the model in order to measure performance of the model when there is no training dataset. The training dataset addition object 373 may include an object for receiving a selection input for the training dataset to be used for training the model by the user. For example, when the computing device 100 receives a selection input for the training dataset addition object 373, the computing device 100 may newly display a screen for adding a training dataset. Further, the computing device 100 may also display a pop-up window for adding a training dataset. The training dataset removal object 375 may include an object for receiving a selection input for a training dataset that is not to be used for training the model by the user. For example, when the computing device 100 receives a selection input for the training dataset removal object 375 after receiving a selection input for a specific training dataset from the user, the computing device 100 may remove the corresponding training dataset from the training dataset output screen 371. Accordingly, the removed training dataset may not be displayed in the screen of the user. The foregoing matter is merely illustrative, and the present disclosure is not limited thereto.

According to the exemplary embodiment of the present disclosure, the training dataset may include at least one training set. The training data may include a predetermined type of data used for intelligence artificial training. According to the exemplary embodiment of the present disclosure, the training dataset may include at least one of a first training dataset used for training the model and a new second training dataset to be used for retraining the model. The first training dataset may include the training dataset used in the training of the model. According to the exemplary embodiment of the present disclosure, the second training dataset may include a new training dataset to be used for retraining the model. The second training dataset may include at least a part of time series data obtained from the sensor in real time and a label corresponding to at least a part of the time series data. The label may include a value obtained by using a model (for example, a trained model performing auto labeling) automatically performing labelling or a value determined based on a selection input of the user. The label may also include a relabeled value because a value obtained by using the trained model corresponds to misclassified data. The misclassified data may refer to data in which the results obtained using the model are misclassified. The misclassified data may be, for example, data that is classified as abnormal although a data subset is a normal data subset. When the computing device 100 obtains a result that the corresponding training data subset is anomaly by using the model, the corresponding training data subset may be a misclassified training data subset. The anomaly may be a part having an atypical pattern, not a normal pattern. The anomaly may include, for example, a part having a defectiveness of a product. The anomaly may also include a malfunctioning part of the motion (for example, a motion of a robot arm) of a machine. The foregoing matter is merely illustrative, and the present disclosure is not limited thereto.

FIG. 6 is a diagram illustrating an example of a training dataset selection screen according to the exemplary embodiment of the present disclosure.

According to the exemplary embodiment of the present disclosure, the computing device 100 may display the training dataset selection screen so that the user is capable of selecting the second training dataset. When the computing device 100 receives a selection input for the training data addition object 373, the computing device 100 may display the training data selection screen.

According to the exemplary embodiment of the present disclosure, the training dataset selection screen 400 may include a screen for allowing the user to select the second training dataset. The computing device 100 may display a screen for allowing the user to select the second training dataset required for improving performance of the model. Accordingly, the user may select the training dataset required for retraining the model through the displayed training dataset selection screen. The computing device 100 may receive a selection input for the training dataset selected by the user. The computing device 100 may train the model by inputting the selected training dataset to the model. The foregoing matter is merely illustrative, and the present disclosure is not limited thereto.

According to the exemplary embodiment of the present disclosure, the training dataset selection screen is the screen for allowing the user to select the second training dataset, and may include at least one of a time variable setting portion for filtering the data obtained by inputting the time series data to the model based on a predetermined first reference, and a data chunk portion 450 for displaying a data chunk in which data obtained by inputting the time series data to the model is divided based on a predetermined second reference. The second training dataset may include a new training dataset to be used for retraining the model. According to the exemplary embodiment of the present disclosure, the time variable setting portion may include a portion for filtering the data obtained by inputting the time series data to the model based on the predetermined first reference. The predetermined first reference may include a reference for a time. The predetermined first reference may include, for example, a period in the unit of year, month, day, hour, minute, and second. The computing device 100 may display only data corresponding to an input period in the training dataset selection screen 400 based on the predetermined first reference input by the user. For example, when the input predetermined first reference is 00:00 to 24:00 on Oct. 30, 2019, the computing device 100 may display only data corresponding to 00:00 to 24:00 on Oct. 30, 2019 in the training dataset selection screen 400. The time variable setting portion may include a period setting portion 410 for filtering data for a specific date or a time setting portion 430 for filtering data for a specific time on a specific date. For example, the computing device 100 may receive a date of Oct. 30, 2019 through the period setting region 410, and receive a time of 6:00 to 12:00 through the time setting portion 430. In this case, the computing device 100 may display data corresponding to 6:00 to 12:00 on Oct. 30, 2019 in the training dataset selection screen 400. In particular, the data displayed in the training dataset selection screen 400 may include data obtained by inputting time series data corresponding to 6:00 to 12:00 on Oct. 30, 2019 to the model. Through this, the computing device 100 may selectively provide the user with data for a time zone requiring relabeling in order to improve the performance of the model. Accordingly, the user may set a time zone in which misclassified data exists and view only the data in the corresponding time zone through the selectively displayed screen. The foregoing matter is merely illustrative, and the present disclosure is not limited thereto.

According to the exemplary embodiment of the present disclosure, the data chunk portion 450 may include a portion for displaying a data chunk in which the data obtained by inputting the time series data to the model is divided based on the predetermined second reference. The data chunk may include a data subset that is at least a part of the dataset. The data chunk may include a part of the data in which the data obtained by inputting the time series data to the model is divided based on the predetermined second reference. The data chunk may be classified as representing a first state and/or a second state. The first state and the second state may refer to a binary classification result when the computing device 100 performs binary classification by using the model. For example, the first state may represent normal and the second state may represent anomaly. The method of dividing the data obtained by inputting the time series data to the model based on the predetermined second reference by the computing device 100 will be described in detail. The foregoing matter is merely illustrative, and the present disclosure is not limited thereto.

According to the exemplary embodiment of the present disclosure, the data chunk may include a statistical characteristic of each dataset obtained by inputting the plurality of pieces of the time series data divided based on the predetermined second reference to the model. The statistical characteristic is the characteristic representing a characteristic of the dataset through a statistical method, and may include a probability distribution, an average, a standard deviation, variance, and the like of the dataset. Accordingly, the data chunk may include probability distribution, an average, a standard deviation, variance, and the like of each dataset obtained by inputting the time series data to the model. For example, when the data chunk is divided at an interval of five minutes, the computing device 100 may determine an average value of the dataset obtained by inputting each time series data subset divided at the interval of five minutes to the model as a statistical characteristic corresponding to the corresponding data chunk. Further, when the data chunk is divided based on the predetermined second reference, the computing device 100 may also determine a median value of the dataset obtained by inputting the time series data subset divided based on the predetermined second reference to the model as a statistical characteristic corresponding to the corresponding data chunk. The computing device 100 may display the statistical characteristic of the data chunk. The foregoing matter is merely illustrative, and the present disclosure is not limited thereto.

According to the exemplary embodiment of the present disclosure, the predetermined second reference may is the reference for detecting the misclassified data among the data obtained by using the model, and include a reference based on which the data obtained by inputting the time series data to the model is divided into the plurality of data chunks based on at least one of a first point at which the data obtained by using the model is changed from the first state to the second state, and a second point at which an output of the model is changed from the second state to the first state. The first state and the second state may refer to the binary classification results when the computing device 100 performs binary classification by using the model. For example, the first state may represent normal and the second state may represent anomaly. The computing device 100 may determine the reference based on which the data chunk is divided with the first point and/or the second point. Accordingly, the computing device 100 may determine the first point at which the obtained data is changed from the first state to the second state as a start point of the data chunk. In this case, the computing device 100 may determine the second point at which the obtained data is changed from the second state to the first state as a termination point of the corresponding data chunk. In the contrast, the computing device 100 may determine the second point at which the obtained data is changed from the second state to the first state as a start point of the data chunk. In this case, the computing device 100 may also determine the first point at which the obtained data is changed from the first state to the second state as a termination point of the corresponding data chunk. Through this, the computing device 100 may classify the data chunk in which the output of the model is normal and the data chunk in which the output of the model is anomaly. Accordingly, the computing device 100 may display the data chunk for each classification result in the data chunk portion 450. The user may view the displayed data chunk and determine which data chunk is the misclassified data. For example, as illustrated in FIG. 6, in the data chunk portion 450, a data chunk 1 451, a data chunk 2 453, and a data chunk 3 455 may be displayed. Herein, the data chunk 1 451 may be the misclassified data (For example, false positive—the case where the obtained data is the normal data, but the output obtained by using the model is anomaly). That is, when the prediction of the model is wrong, the computing device 100 may receive an input signal from the user and relabel the misclassified data chunk. That is, when the obtained data is the normal data, but the output obtained by using the model is anomaly, the computing device 100 may relabel the corresponding data as normal. The computing device 100 may retrain the model by inputting the relabeled data chunk to the model. Through the process, accuracy of the prediction by the model may be improved. In the case of the data chunk 3 455, a result value obtained by using the model may be normal. Further, the input data may also be normal. In this case, the data chunk 3 455 may be an accurately predicted and/or classified dataset. Accordingly, for the data chunk 3, a need for retraining the model by inputting the data to the model again is decreased. In this case, the computing device 100 may not relabel the data chunk 3. The foregoing matter is merely illustrative, and the present disclosure is not limited thereto.

FIG. 7 is a diagram illustrating an example of the model archive output screen according to the exemplary embodiment of the present disclosure.

According to the exemplary embodiment of the present disclosure, the computing device 100 may display the model archive output screen 510 in the second output portion. The computing device 100 may receive an input signal for the model archive selection object 337 and display the model archive output screen 510 in the second output portion 340.

According to the exemplary embodiment of the present disclosure, the model archive output screen 510 may include a screen for displaying information about each of the plurality of models. The model archive output screen 510 may include at least one of a model list output portion 513 for displaying the plurality of models stored in the model archive so that the user views the plurality of models at a glance, and a model information output portion 515 for displaying information about a model selected according to the reception of a selection input signal of the user. The model archive may include a storage place in which the plurality of models is stored. The model archive may include, for example, a trained model, a non-trained model, a re-trained model, and the like. The computing device 100 may receive an input signal of the user and call a model selected by the user from the model archive. According to the exemplary embodiment of the present disclosure, the model list output portion 513 may include a portion for displaying the plurality of models stored in the model archive so that the user views the plurality of models at a glance. The model list output portion 513 may include a portion for displaying the models selected based on the selection input of the user so that the user views the models at a glance. For example, the model list output portion 513 may include a model included in a project, a model selected by the user, a model recommended to the user, and the like. According to the exemplary embodiment of the present disclosure, the model information output portion 515 may include a portion for displaying information about a model selected according to the reception of the selection input signal of the user. The model information output portion 515 may include a portion in which, for example, a model name, a model state (for example, before training, after training, and during training), a model generation date, and information about the training dataset used for training the model) are displayed. The foregoing matter is merely illustrative, and the present disclosure is not limited thereto.

FIG. 8 is a diagram illustrating an example for explaining a hit model according to the exemplary embodiment of the present disclosure.

According to the exemplary embodiment of the present disclosure, the model list may include a model 521 determined based on a hit rate of each of the plurality of models included in the model archive.

According to the exemplary embodiment of the present disclosure, FIG. 8 illustrates the model archive 520 and the hit model 521. The hit model 521 may include a model determined based on a hit rate of each of the plurality of models included in the model archive in order to recommend the model corresponding to the newly input data to the user. The hit model 521 may mean the model which determines the input data as normal or abnormal. The model that makes a final determination on the input data among the plurality of models may be set as the hit model 521. For the newly input time series data, the user may not know which model outputs an optimum result. Further, when the performance of the models is compared by inputting the newly input time series data to all of the models included in the model archive, lots of time and cost may be consumed. Accordingly, for the newly input time series data, the computing device 100 may select a model having a high probability of hitting among the models stored in the model archive 520 and display the model having the highest possibility of hitting. Through this, the user may quickly obtain an appropriate model for the newly input data without going through an experimental process. The foregoing matter is merely illustrative, and the present disclosure is not limited thereto.

FIG. 9 is a diagram illustrating an example for explaining a combined model according to the exemplary embodiment of the present disclosure.

According to the exemplary embodiment of the present disclosure, the model list may include a model 525 newly generated by combining the models having the similar statistical characteristic among the plurality of models included in the model archive.

According to the exemplary embodiment of the present disclosure, FIG. 9 illustrates the model archive 520, models 523 having a similar distribution, and a combined model 525. The computing device 100 may combine the models 523 having the similar distribution and newly generate the combined model 525. That is, the computing device 100 may also generate a model having a high probability of being used for the newly input data by combining one or more models having a low probability of being used for the newly input data. Through this, the computing device 100 may also quickly calculate an appropriate model for the newly input data by selectively calculating a hit rate for each of the models included in the group having the high probability of being used. The foregoing matter is merely illustrative, and the present disclosure is not limited thereto.

FIG. 10 is a diagram illustrating an example of the sensed anomaly output screen according to the exemplary embodiment of the present disclosure.

According to the exemplary embodiment of the present disclosure, the computing device 100 may display the detected anomaly output screen in the second output portion. The computing device 100 may receive an input signal for the detected anomaly output selection object 339 and display the detected anomaly output screen 530 in the second output portion 340.

According to the exemplary embodiment of the present disclosure, the computng device 100 may display the sensed anomaly output screen 530 in the second output portion. The sensed anomaly output screen 530 may include an anomaly detection result output portion for displaying an anomaly detection result obtained by using the model.

According to the exemplary embodiment of the present disclosure, the sensed anomaly output screen 530 may include a screen for displaying information related to anomaly data among the data obtained by using the model. The sensed anomaly output screen 530 may include at least one of an anomaly detection result output portion 531 for displaying a list of the anomaly data obtained by using the model, and an anomaly information output portion 533 for displaying information about the anomaly data selected according to the reception of the selection input signal of the user. The anomaly detection result output portion 531 may include a portion for displaying a list of the anomaly data obtained by using the model. For example, the computing device 100 may display the data classified as anomaly among the data obtained by using the model in the anomaly detection result output portion 531. The anomaly information output portion 533 may include a portion for displaying information about the anomaly data selected according to the reception of the selection input signal of the user. For example, the computing device 100 may display information about the anomaly data selected according to the selection input signal of the user, that is, a start time at which anomaly occurs, an end time at which anomaly ends, and a period in which anomaly occurs. The foregoing matter is merely illustrative, and the present disclosure is not limited thereto.

FIG. 11 is a diagram illustrating an example of the model performance output screen according to the exemplary embodiment of the present disclosure.

According to the exemplary embodiment of the present disclosure, the computing device 100 may display the model performance output screen in the second output portion. The computing device 100 may receive an input signal for the performance monitoring selection object 331 and display the model performance output screen 550 in the second output portion 340.

According to the exemplary embodiment of the present disclosure, as illustrated in FIG. 11, the computing device 100 may display the model performance output screen 550 in the second output portion. The model performance output screen 550 may include a screen for displaying performance information of the model. The performance information of the model may include all of the information related to the performance of the model. For example, the performance information of the model may include a measure of how accurate the model outputs a prediction result value for the input data. Further, the performance information of the model may include a prediction value obtained by the computing device 100 by using the model. The foregoing matter is merely illustrative, and the present disclosure is not limited thereto.

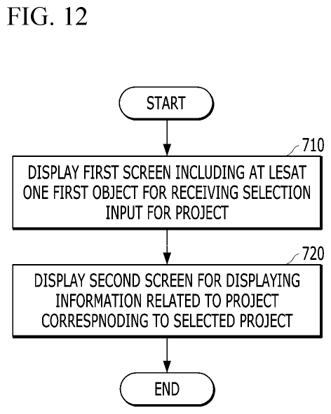

FIG. 12 is a flowchart illustrating the method of training the neural network according to the exemplary embodiment of the present disclosure.

According to the exemplary embodiment of the present disclosure, the method of training the neural network may include displaying a first screen including at least one first object for receiving a selection input for a project (710).

According to the exemplary embodiment of the present disclosure, the method of training the neural network may include displaying a second screen for displaying information related to the project corresponding to the selected project (720).

According to the exemplary embodiment of the present disclosure, the second screen may include at least one of a first output portion for displaying time series data obtained from a sensor, a selection portion including at least one second object for receiving a selection input related to a model retraining, and a second output portion for displaying information corresponding to the second object.

According to the exemplary embodiment of the present disclosure, the project is a project related to artificial intelligence for achieving a specific goal by using the artificial intelligence, and the specific goal includes the goal of improving the performance of the model to which the artificial intelligence is applied.

According to the exemplary embodiment of the present disclosure, the selection portion is a portion including an object for displaying the information related to the training of the model in the second output portion, and may include at least one of a performance monitoring selection object for displaying performance information of the model in the second output portion, a training dataset selection object for displaying training dataset information related to the training of the model in the second output portion, a training console selection object for displaying information about a current training progress status of the model in the second output portion, a model archive selection object for displaying information about at least one model in the second output portion, and a sensed anomaly output selection object for displaying information on anomaly information sensed by using the model in the second output portion.

According to the exemplary embodiment of the present disclosure, the method of training the neural network may include further include displaying a training dataset output screen in the second output portion, and the training dataset output screen may include at least one of a training dataset addition object for receiving a training dataset list in which at least one training dataset is listed and a selection input for a training dataset to be used for training the model by the user, and a training dataset removal object for receiving a selection input for a training dataset that is not to be used for training the model by the user.

According to the exemplary embodiment of the present disclosure, the training dataset may include at least one of a first training dataset used in training of the model or a new second training dataset to be used for retraining the model, and the second training dataset may include at least a part of the time series data obtained from a sensor in real time and a label corresponding to the time series data.

According to the exemplary embodiment of the present disclosure, the training dataset selection screen is the screen for allowing the user to select the second training dataset, and may include at least one of a time variable setting portion for filtering the data obtained by inputting the time series data to the model based on a predetermined first reference, and a data chunk portion for displaying a data chunk in which data obtained by inputting the time series data to the model is divided based on a predetermined second reference.

According to the exemplary embodiment of the present disclosure, the data chunk may include a statistical characteristic of each dataset obtained by inputting the plurality of pieces of the time series data divided based on the predetermined second reference to the model.

According to the exemplary embodiment of the present disclosure, the predetermined second reference is the reference for detecting the misclassified data among the data obtained by using the model, and may include a reference based on which the data obtained by inputting the time series data to the model is divided into the plurality of data chunks based on at least one of a first point at which the data obtained by using the model is changed from the first state to the second state, and a second point at which an output of the model is changed from the second state to the first state.

According to the exemplary embodiment of the present disclosure, the data chunk may include at least one of a data chunk including a data chunk calculated through a data chunk recommendation algorithm that recommends a data chunk to be used for retraining the model to the user, at least one data chunk having a similar statistical characteristic to that of the data chunk selected according to the reception of a selection input signal of the user.

According to the exemplary embodiment of the present disclosure, the model archive output screen may be a screen for displaying information about each of the plurality of models, and the model archive output screen may include at least one of a model list output portion for displaying the plurality of models stored in the model archive so that the user views the plurality of models at a glance, and a model information output portion for displaying information about a model selected according to the reception of a selection input signal of the user.

According to the exemplary embodiment of the present disclosure, the model list may include at least one of a model trained while progressing the project, a model retrained by inputting the second training dataset to the trained model, a model newly generated by combining the models having the similar statistical characteristic among the plurality of models included in the model archive, and a model determined based on a hit rate of each of the plurality of models included in the model archive in order to recommend the model corresponding to the newly input data to the user.

According to the exemplary embodiment of the present disclosure, the sensed anomaly output screen is a screen for displaying information related to anomaly data among the data obtained by using the model, and may include at least one of an anomaly detection result output portion for displaying a list of the anomaly data obtained by using the model, and an anomaly information output portion for displaying information about the anomaly data selected according to the reception of the selection input signal of the user.

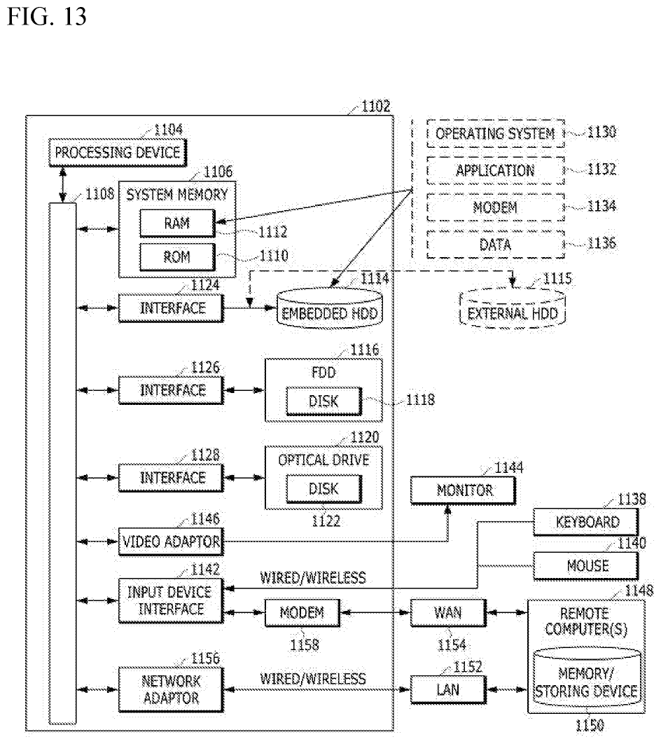

FIG. 13 is a simple and general schematic diagram illustrating an example of a computing environment in which the exemplary embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be positioned in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a Random Access Memory (RAM), a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, radio frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system storage unit 1106, and a system bus 1108. The system bus 1108 connects system components including the system memory 1106 (not limited) to the processing device 1104. The processing device 1104 may be a predetermined processor among various commonly used processors 110. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable storage media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be appreciated well that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor 110-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, electric fields or particles, optical fields or particles, or a predetermined combination thereof.

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer program stored in a computer readable medium, wherein when the computer program is executed by one or more processors of a computing device, the computer program performs operations to provide methods for training neural networks, and the operations comprise:
displaying, by a processor, a first screen including at least one first object receiving a selection input for a project; and
displaying, by the processor, a second screen including information related to the project corresponding to the selected project,
wherein the second screen includes at least one of a first output portion for displaying time series data obtained from a sensor or a second output portion for displaying a selection portion including at least one second object receiving a selection input for a model retraining or information corresponding to the second object.

2. The computer program according to claim 1, wherein the project is a project related to an artificial intelligence for achieving a specific goal based on the artificial intelligence, and
the specific goal includes the goal of improving the performance of the model applied the artificial intelligence.

3. The computer program according to claim 1, wherein the selection portion is a portion including an object for displaying information related to a model training in the second output portion, and
the selection portion includes at least one of a performance monitoring selection object for displaying a model performance information in the second output portion, a training data set selection object for displaying a training data set information related to the model training in the second output portion, a training console selection object for displaying a training progress status information related to the current model in the second output portion, a model archive selection object for displaying information related to at least one or more models in the second output portion, or a sensed anomaly output selection object for displaying anomaly information sensed by using the model in the second output portion.

4. The computer program according to claim 1, wherein the operations further comprise displaying a training data set output screen in the second output portion, and
training data set output screen includes at least one of a training data set list for listing at least one training data set, a training data set additional object for receiving a selection input for the training data set to be used in a model training from a user, or a training data set removal object for receiving a selection input for the training data set to be not used in the model training from a user.

5. The computer program according to claim 4, wherein the training data set includes at least one of a first training data set used in a model training or a second training data set to be newly used in a model retraining, and
second training data set includes at least a part of the time series data obtained from a sensor in real time and a label corresponding to the time series data.

6. The computer program according to claim 1, wherein the operations further comprise displaying a training data set selection screen to be selected the second training data set from a user.

7. The computer program according to claim 6, wherein the training data set selection screen is a screen to be selected the second training data set from a user, and
training data set selection screen includes at least one of a time variable setting portion for filtering data obtained by inputting the time series data into the model based on a predetermined first reference or a data chunk portion for displaying data chunk dividing from data obtained by inputting the time series data into the model based on a predetermined second reference.

8. The computer program according to claim 7, wherein the data chunk includes statistical features of each data set obtained by inputting the plurality of time series data divided based on the predetermined second reference into the model.

9. The computer program according to claim 7, wherein the predetermined second reference is a reference for detecting a misclassification data from data obtained by using the model, and
the predetermined second reference includes a reference for dividing data obtained by inputting the time series data into the model into a plurality of data chunks based on at least one of a first point where the data obtained by using the model changes from a first state to a second state, a second point where an output of the model changes from the second state to the first state, a third point existing in the output of the model in the first state, or a fourth point existing in the output of the model in the second state.

10. The computer program according to claim 7, wherein the data chunk includes at least one of a data chunk calculated from a data chunk to be used in a model retraining through a data chunk recommendation algorithm or at least one data chunk with similar statistical characteristics to the data chunk selected from receiving a user selection input signal.

11. The computer program according to claim 1, wherein the operations further comprise displaying a model archive output screen in the second output portion.

12. The computer program according to claim 11, wherein the model archive output screen is a screen for displaying information of each model among a plurality of models, and
the model archive output screen includes at least one of a model list output portion for displaying to be seen the plurality of models stored in the model archive at a glance or a model information output portion for displaying information of the model selected from receiving a user selection input signal.

13. The computer program according to claim 12, wherein the model list includes at least one of a model trained by progressing the project, a model retrained by inputting the second training data set into the trained model, a model generated newly by integrating models having similar statistical characteristics among the plurality of models included in the model archive, or a model determined based on a hit rate of each model among the plurality of models included in the model archive in order to recommend a model corresponding to a data inputted newly to a user.

14. The computer program according to claim 1, wherein the operations further comprise displaying an anomaly output screen sensed in the second output portion.

15. The computer program according to claim 14, wherein the sensed anomaly output screen is a screen for displaying information related to an anomaly data from data obtained by using the model, and
the sensed anomaly output screen includes at least one of an anomaly sensing result output portion for displaying an anomaly data list obtained by using the model or an anomaly information output portion for displaying information of the anomaly data selected from receiving a user selection input signal.

16. A method for training neural networks, comprising:
displaying, by a processor, a first screen including at least one first object receiving a selection input for a project; and
displaying, by the processor, a second screen including information related to the project corresponding to the selected project,
wherein the second screen includes at least one of a first output portion for displaying time series data obtained from a sensor or a second output portion for displaying a selection portion including at least one second object receiving a selection input for a model retraining or information corresponding to the second object.

17. A computing device for providing methods for training neural networks, including:
a processor including one or more cores; and
a memory,
wherein the processor is configured to:
display a first screen including at least one first object receiving a selection input for a project; and
display a second screen including information related to the project corresponding to the selected project,
wherein the second screen includes at least one of a first output portion for displaying time series data obtained from a sensor or a second output portion for displaying a selection portion including at least one second object receiving a selection input for a model retraining or information corresponding to the second object.
